(19) United States
(12) Patent Application Publication
(10) Pub. No.: US 2004/0162965 A1
(43) Pub. Date: Aug. 19, 2004

(54) Information processing unit

(76) Inventors: Makoto Ogawa, Tokyo (JP); Tadashi Shibata, Tokyo (JP)

Correspondence Address: KENYON & KENYON, 1500 K STREET, N.W., SUITE 700, WASHINGTON, DC, 20005, US

(21) Appl. No.: 10/779,801

(22) Filed: Feb. 18, 2004

(30) Foreign Application Priority Data
Feb. 18, 2003 (JP) 2003-039741

(51) Int. Cl. G06F 9/30

(52) U.S. Cl. 712/208; 712/214

(57) ABSTRACT

In each processor of a plurality of processors provided in one chip, an instruction to be executed by an instruction code inputted thereto is to be determined uniquely, based on input history of the instruction codes, from the plural instructions assigned to the instruction codes by an decoder circuit. Accordingly, every instruction can be expressed by a short instruction code length, with one instruction code corresponding to the plural instructions, as well as different kinds of instructions can be executed, based on the input history of the instruction codes, by the same instruction code.

### CROSS-REFERENCE TO RELATED APPLICATIONS

This application is based upon and claims the benefit of priority from the prior Japanese Patent Application No. 2003-039741, filed on Feb. 18, 2003, the entire contents of which are incorporated herein by reference.

### BACKGROUND OF THE INVENTION

1. Field of the Invention

The present invention relates to an information processing unit, particularly, the present invention is suitable for applying to an information processing unit having a plurality of processors which are able to operate in parallel in one chip.

2. Description of the Related Art

There exists a SIMD-(Single Instruction Multiple Data)-parallel processor as one of parallel computers. The SIMD parallel processor has a plurality of processors in one chip, executing one processing corresponding to a supplied instruction thereto in parallel simultaneously by the plural processors.

Each processor in the SIMD parallel processors consists of a processor element and a memory. In the SIMD processor, as one processing corresponding to the supplied instruction is to be operated in parallel by all processors, the memory of each processor holds only data.

Therefore, though the SIMD processor has the plural processors, it is not able to execute different kinds of processing by each processor in parallel. For example, while executing a retrieval processing by some processors, the SIMD processor can not execute a detailed comparing processing by other processors in parallel, in a processing of matching data and so on.

In order to execute different kinds of processing in parallel by the plural processors, it is necessary that program (instruction) should be held in the memory of each processor. However, in an instruction set used for the general-purpose processor in recent years, a single instruction is organized by 32-bit or 64-bit. If the memory of each processor holds the program by which the same processing as the general-purpose processor execute, high memory capacity is required. However, in order to provide many processors in one chip, the memory capacity of each processor is preferable to be small.

### SUMMARY OF THE INVENTION

In view of the above, it is an object of the present invention to enable a plurality of processors provided in one chip to execute various and different kinds of processing in parallel, while lowering increase of the memory capacity required to hold program in each processor.

An information processing unit according to the present invention is an information processing unit having a plurality of processors in one chip, which is characterized by that the plural processors can execute the instructions independently. Each processor includes a decoder circuit for determining the instruction to be executed uniquely, based on input history of instruction codes, by an instruction code inputted to the processor from a plurality of instructions which are assigned to the instruction code.

According to the present invention, as one instruction code corresponds to the plurality of instructions, the instruction code length can be shorter than the case that different instruction codes are made to correspond to the plurality of instructions, so that different kinds of processing can be performed by the same instruction code.

### BRIEF DESCRIPTION OF THE DRAWINGS

FIG. 1 is a block diagram showing a configuration of a parallel processor to which an information processing unit applied according to an embodiment of the present invention;

FIG. 2 is a view explaining the concept of processing operation in each processor according to the present embodiment;

FIG. 3 is a block diagram showing a configuration of an instruction decoding portion;

FIG. 4 is a view showing an example of a look up table for setting the rule for changing a group code; and

FIG. 5 is a view showing an example of a group change determination circuit.

### DETAILED DESCRIPTION OF THE PREFERRED EMBODIMENTS

An embodiment of the present invention will be described hereinafter in reference to the drawings.

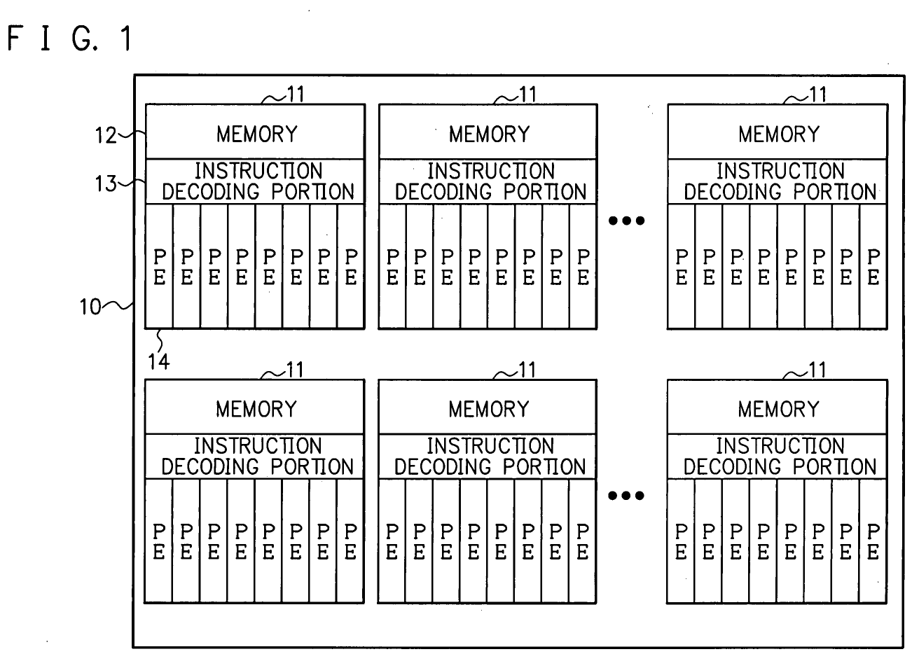

FIG. 1 is a block diagram showing a configuration of a parallel processor 10 to which the information processing unit of the embodiment according to the present invention applies.

The parallel processor 10 is composed of plural processors 11 which are connected to each other in one chip. Each processor 11 has a memory 12, an instruction decoding portion 13 and a plurality of processor elements (PE) 14, which is able to execute a certain instruction independently. The memory 12 includes a program memory (instruction memory area) for storing a program (instruction) and a data memory (data memory area) for storing data.

The instruction decoding portion 13 decodes the instruction, reading out of the program memory of the memory 12. Also the instruction decoding portion 13 controls an internal resister described later and the processor elements 14 based on the result of decoding. Detailed description of the instruction decoding portion 13 will be given later. The processor elements 14 are the conventionally known SIMD processor elements, executing operations according to control signals supplied from the instruction decoding portion 13.

Though the processors 11 each have 8-processor elements 14 as one example shown in FIG. 1, each processor 11 is able to have optional numbers of processor elements 14, for example, a single processor element will be acceptable.

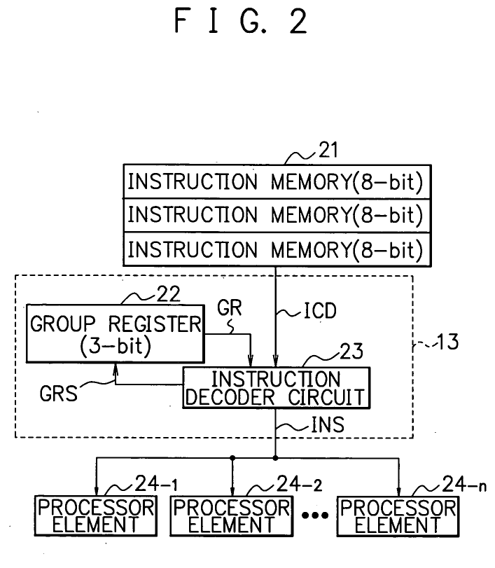

FIG. 2 is a view explaining the concept of processing operation in each processor 11. In the following description, one instruction code is organized with 8-bit, and a group code described later is organized with 3-bit.

In FIG. 2, 21 is an instruction queue, being composed of plural instruction memories so as to hold plural instruction codes. Each instruction memory has 8-bit memory area.

The instruction decoding portion 13 includes a group register 22 and an instruction decoder circuit 23. The group register 22 is a register for storing a group code, having 3-bit memory area. The instruction decoder circuit 23 decodes the instruction code, referring the group code to execute control operation according to the decoded result. 24-ᵢ [“i” is a subscript, i=1˜n (n is an optional natural number)] are processor elements equivalent to the processor elements 14 shown in FIG. 1.

The group code designates one of the groups into which the input instructions concerning the processing executable in the processor 11 are sorted on a predetermined rule. The group codes are different value from each other in every group.

The input instructions are sorted into groups, such as the instruction of the four basic operations like addition, subtraction, multiplication, and division including the shift operation or the bit operation, and the instruction of the WTA operation used for matching data and the like, the burst operation instruction, the register operation instruction, the memory control instruction, the flow control instruction, the scalar instruction and so on. The instruction codes of respective input instructions are different from each other in one single group, and the same instruction code can exist in another group. Namely, plural instructions from different groups can be expressed by one instruction code.

Besides, there exists a global instruction which does not belong to any group (which is independent of the groups). The global instructions are, for example, a group change instruction for changing the group code, a group temporary change instruction for changing the group code of immediately following instruction, an alias execution instruction for executing an optional instruction previously assigned and the like.

The operation will be described as follows.

The instruction decoder circuit 23 read an instruction code ICD 1-byte (8-bits) at a time out of the instruction memory of the instruction queue 21. The instruction decoder circuit 23 adds a group code GR supplied from the group register 22 to the read-out instruction code ICD and decodes them. Namely, the instruction decoder circuit 23 decodes 11-bit code (hereinafter referred to as ‘internal instruction code’) consisting of the 3-bit group code GR and the 8-bit instruction code.

When the instruction is a standard instruction, for example, the instruction for four basic operations and the like as one result of decoding, the instruction decoder circuit 23 supplies a control signal INS corresponding to the instruction to each processor elements 24-ᵢ. When the instruction is to change the group code, such as the group (temporary) change instruction as another result of decoding, the instruction decoder circuit 23 writes the thus-changed group code GRS designated by this instruction into the group register 22.

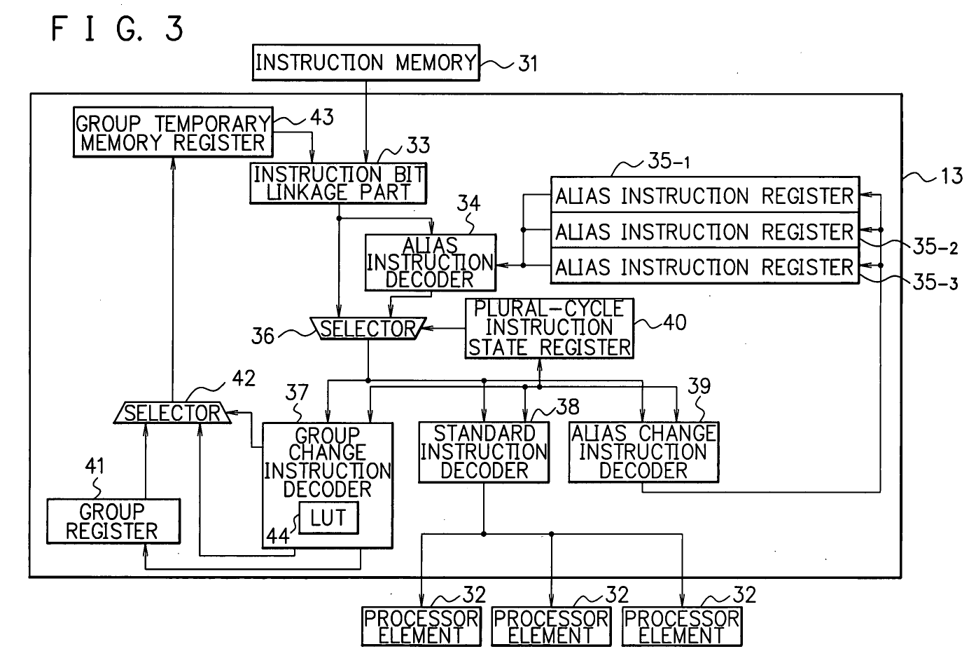

FIG. 3 is a block diagram showing a configuration example of the instruction decoding portion 13.

In FIG. 3, 31 is an instruction memory for holding the instruction code, 32 is processor elements for executing various kinds of processing according to the control by the instruction decoding portion 13.

The instruction decoding portion 13 includes an instruction bit linkage part 33, an alias instruction decoder 34, an alias instruction register 35₋ⱼ (“j” is a subscript and an optional natural number), a first selector 36, a group change instruction decoder 37, a standard instruction decoder 38, an alias change instruction decoder 39, a plural-cycle instruction state register 40, a group register 41, a second selector 42, and a group temporary memory register 43.

The instruction bit linkage part 33 reads the instruction code out of the instruction memory 31 1-byte at a time. This instruction bit linkage part 33 is defined based on the instruction code which is inputted in the past so as to output the internal instruction code, with linking (adding) the group code held in the group temporary memory register 43 to the instruction code read out of the instruction memory 31.

The alias instruction decoder 34 determines whether the internal instruction code supplied from the instruction bit linkage part 33 is an alias execution instruction which replaces the internal instruction code with the code of the alias instruction, or not. Depending on the determination, when the internal instruction code is the alias execution instruction, the alias instruction decoder 34 reads the alias instruction (the internal instruction to be replaced) out of the alias instruction register 35₋ⱼ corresponding to the group code of the internal instruction code so as to output the instruction.

The alias instruction registers 35₋ⱼ are set in every group, in which the internal instruction codes of the instruction of other groups assigned as the alias instruction are stored respectively. As for the alias instruction registers 35₋ⱼ, they are not only limited to those in the embodiment shown in FIG. 3, but also to another configuration that has a common alias instruction in all groups, or a still another configuration that has plural alias instructions in each group.

The first selector 36 selectively outputs the internal instruction code supplied from the instruction bit linkage part 33, or the internal instruction code supplied from the alias instruction decoder 34.

The group change instruction decoder 37 changes one group code into another new group code, when the internal instruction code supplied from the first selector 36 is the group change instruction or the group temporary change instruction. In addition to the group (temporary) change instruction, the group change instruction decoder 37 can change the group code into a new group code when the internal instruction code supplied from the first selector 36 satisfies the rule for changing the group code which has been previously defined. The rule for changing the group code can be defined, with for example a look up table (LUT) 44, which relates the internal instruction code with the group code to be changed, being provided in the group change instruction decoder 37.

The group change instruction decoder 37 writes a new group code value into the group resister 41 in case of changing the group code based on the group change instruction or the rule for changing the group code. Hereby, the value held in the group register 41 is replaced with the new group code value. Further, the value held in the group register 41 is supplied to the group temporary memory register 43 through the second selector 42 to be held therein.

When only the group code of immediately following instruction is to be changed based on the group temporary change instruction, the group change instruction decoder 37 supplies the subject group code value to the group temporary memory register 43 through the second selector 42. Hereby, the value held in the group temporary memory register 43 is replaced with a new group code value. In this case, the group change instruction decoder 37 does not write the group code into the group register 41.

The standard instruction decoder 38 decodes the internal instruction code and outputs the control signal to the processor elements 32 in the same way as the well-known processor, when the internal instruction code supplied from the first selector is a standard instruction (such as the four basic operation).

The alias change instruction decoder 39 rewrites the value of the alias instruction register 35₋ⱼ, when the internal instruction code supplied from the first selector 36 is the alias change instruction code. Specifically, the alias change instruction decoder 39 rewrites the value of the alias instruction register 35₋ⱼ corresponding to the group code whereof change is indicated by the internal instruction code, into the internal instruction code (the group code as well as the instruction code) of the instruction code to be replaced according to the internal instruction.

The plural-cycle instruction state register 40 controls, when the alias instruction or the like replaced by the alias execution instruction is the instruction which occupies more than 2-byte length, the first selector 36 to replace only the first 1-byte of the instruction with the alias instruction and ignore the alias instruction over 2-byte.

The plural-cycle instruction state register 40 therefore controls the first selector 36 so as to only select 1-byte of internal instruction code from the alias instruction decoder 34 and subsequently select the internal instruction code from the instruction bit linkage part 33 over 2-byte. That is why the first 1-byte of the instruction indicates the instruction itself and the instruction over 2-byte may be data or the like, when the alias instruction or the like has more than 2-byte length. Incidentally, the group change instruction decoder 37, the standard instruction decoder 38, the alias change instruction decoder 39 and the plural-cycle instruction state register 40 communicate with each other for operation.

The second selector 42 supplies the group code value held in the group register 41 or the group code value supplied from the group change instruction decoder 37 to the group temporary memory register 43 selectively, according to the control of the group change instruction decoder 37. Specifically, the second selector 42 selects and outputs the value from the group change instruction decoder 37 only in the case that the group code is changed according to the group temporary change instruction. Otherwise, the second selector 42 will select and output the value from the group register 41.

Though the instruction decoding portion 13 does not include a flow control circuit and the like such as a program counter, a register, a conditional branch, those can be provided therein.

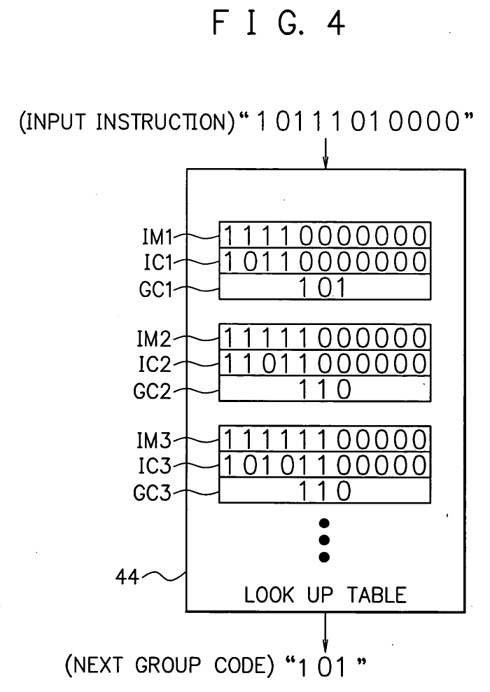

FIG. 4 is an explanatory view showing an example of the LUT 44, which sets the rule for changing the group code.

As shown in FIG. 4, the rule for changing the group code, as one group, is to be defined with an instruction mask IMₖ (“k” is a subscript and optional natural number and, the followings are the same condition), an instruction code ICₖ and a changed group code GCₖ. The instruction mask IMₖ and the instruction code ICₖ are defined by 11-bit equivalent to the group code (3-bit) and the instruction code (8-bit), and the group code GCₖ is defined by the group code only (3-bit).

The instruction mask IMₖ sets a bit to be masked by the input instruction (internal instruction code). The instruction mask IMₖ defines “0(Zero)” to the bit to be masked, and also “1” to the bit not to be masked.

The instruction code ICₖ defines the internal instruction code to be compared with the input instruction. The instruction code ICₖ defines “0(Zero)” to the bit to be masked and also defines a certain value to the bit not to be masked by the instruction mask IMₖ. The group code GCₖ defines the changed group code to be set newly, in the case that the group code agrees with a condition set by the instruction mask IMₖ and the instruction code ICₖ.

For example, as shown in FIG. 4, when the value “11110000000”, “10110000000”, “101” are set to the instruction mask IM1, the instruction code IC1, the group code GC1 respectively, high order 4-bit of the instruction mask IM1 is “1”. When the value of high order 4-bit of the input instruction is compared with the value of high order 4-bit of the instruction code IC1, if agreed, the group code will be changed into “101”. In the case that the value of high order 4-bit of the input instruction is “1011”, the group code will be changed into “101”.

Similarly, when the value “11111000000”, “11011000000”, “110” are set to the instruction mask IM2, the instruction code IC2, the group code GC2 respectively, the group code will be changed into “110”, if the value of high order 5-bit of the input instruction is “11011”.

The LUT44 shown in FIG. 4 is just one example, and does not limited to it. For another example, the LUT, wherein the plural groups of the instruction mask and the instruction code and one changed group code are set as one group, and the group code will be changed according to plural input instructions including the previous input instruction, can be acceptable.

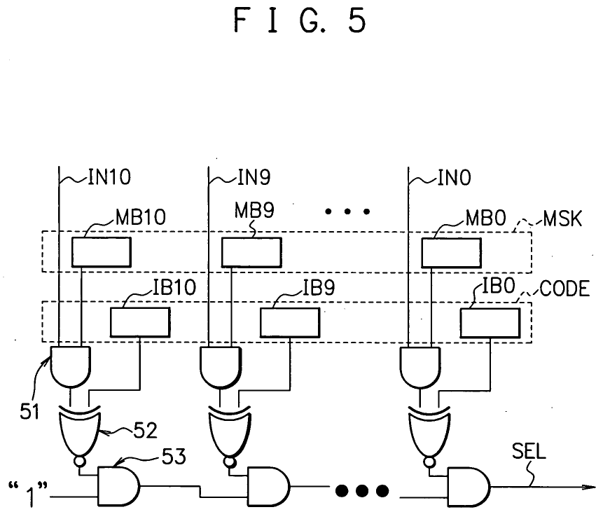

FIG. 5 is a view showing one example of a group change determination circuit for determining whether the input instruction (internal instruction code) satisfies the rule for changing the group code shown in FIG. 4, or not. This determination circuit is provided to for example the group change instruction decoder 37.

As shown in FIG. 5, in the determination circuit, the logical multiplication operation between one bit INₘ (“m” is a subscript, and an integer number of 0˜10, and the followings are the same condition) in the input instruction and one bit MBₘ in the instruction mask MSₖ is performed at a logical multiplication operation (AND) circuit 51 in every corresponding bit. Further, the exclusive negative OR operation between the operation result of the AND circuit 51 and one bit IBₘ in the instruction code CODE is performed at an exclusive negative OR operation (EX-NOR) circuit 52 in every corresponding bit. By means of an AND circuit 53 connected dependently, the logical multiplication operation of all operation results of every EX-NOR circuit 52 is carried out so as to output the operation result thereof as a selecting signal SEL.

By the determination circuit thus being configured, the selecting signal will be high-level only in the case that the input instruction agrees with the condition of the changing rule set by the instruction mask MSₖ and the instruction code CODE, as a result, the changed group code set by the said changing rule will be selected.

According to the present embodiment as described above, in the parallel processor 10 having the plural processors 11, the instruction decoding portion 13 in each processor 11 adds the group code which is determined by the past instruction code to the instruction code which is read out of the instruction memory so as to generate the internal instruction code. Further, the instruction decoding portion 13 performs various kinds of controls, determining the instruction to be executed uniquely, based on the internal instruction code, from the plurality of instructions assigned to the instruction code which is read out.

Accordingly, the plural instructions correspond to one instruction code to express every instruction by short instruction code length, so that the increase of the capacity required to the program memory holding the said instruction code can be lowered. Moreover, different kinds of processing can be performed with the same instruction code, according to the group code determined by the past instruction code, as a result, various and advanced processing can be executed comparing the hitherto processor. Besides, by setting the alias instruction to which optional instruction is assigned, the instruction of other groups can be executed by one instruction code immediately.

In the above described embodiment, the instruction code is set by 8-bit, and the group code is set by 3-bit, however, it is an preferable example and the present invention does not limited in it.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

As described above, according to the present invention, without different kinds of instruction codes corresponding to every instruction which can be executed in the processor, one instruction code corresponds to the plurality of instructions and each processor determines the instruction to be executed uniquely, based on the input history of instruction codes, from the plural instructions by the instruction code. Thus, every instruction can be expressed by short instruction code length so that the increase of memory capacity required to hold the instruction code at each processor is well lowered. Also, if the same instruction code is inputted, different kinds of instructions can be executed according to the input history of the instruction code, as a result, various and different kinds of processing can be executed by the plurality of processors in parallel.

What is claimed is:

1. An information processing unit, comprising a plurality of processors in one chip, wherein said plural processors execute an instruction independently, and wherein said each processor comprises a decoder circuit for determining the instruction to be executed uniquely, based on input history of instruction codes, by an instruction code inputted thereto from a plurality of instructions which are assigned to the instruction code.

2. The information processing unit according to claim 1, wherein said decoder circuit holds a prescribed information corresponding to the input history of the instruction codes and determines the instruction to be executed uniquely based on the information as well as the instruction code inputted thereto.

3. The information processing unit according to claim 1, further comprising an instruction to which the optional instruction code is assigned.

4. The information processing unit according to claim 1, further comprising an instruction which is determined by the instruction code inputted thereto, regardless of the input history of the instruction codes.

5. An information processing unit, comprising a plurality of processors which execute instructions independently in one chip, wherein the instructions executable by said processor are sorted into a plurality of groups of instructions, with instruction codes which are different from each other in the same group being added to each instruction, wherein said processor selects the group of instruction corresponding to the instruction code inputted thereto based on the input history of the instruction code to determine the instruction uniquely by the instruction code inputted thereto.

6. An information processing unit, comprising a plurality of processors which execute instructions independently in one chip, wherein the instructions executable by said processor are sorted into a plurality of groups of instructions indicated by a group code, with the instruction codes which are different from each other in the same group of instruction being added to each instruction, and wherein said each processor comprises a decoder circuit which determines the instruction to be executed uniquely based on said group code corresponding to input history of the instruction codes and the instruction code inputted thereto, and a processor element which executes an operation corresponding to a control signal supplied from said decoder circuit.

7. The information processing unit according to claim 6, wherein said each processor further comprises a group resister which stores the group codes set on the basis of the input history of said instruction code.

8. The information processing unit according to claim 7, wherein said each processor further comprises a look up table which defines the rule for changing the group code stored in said group register.

9. The information processing unit according to claim 8, wherein said look up table defines a combination of an instruction mask for setting bit to be masked, an instruction code for comparing the instruction with the internal instruction code generated by the group code and the input instruction code, and a changed group code.

10. The information processing unit according to claim 6, wherein the instruction executable by said processor includes an alias instruction which assigns in advance the optional instruction for the internal instruction code generated by the group code and the input instruction code.
